(19) United States
(12) Patent Application Publication
(10) Pub. No.: US 2002/0012434 A1
(43) Pub. Date: Jan. 31, 2002

(54) Method for creating sites, a method for editing sites, systems for performing these methods and use of such systems

(76) Inventors: Martin Frederiksen, Arhus C (DK); Jens Willy Johannsen, Arthus C (DK); Soren Thulesen, Arthus C (DK)

Correspondence Address: BIRCH STEWART KOLASCH & BIRCH, PO BOX 747, FALLS CHURCH, VA, 22040-0747, US

(21) Appl. No.: 09/813,150

(22) Filed: Mar. 21, 2001

Related U.S. Application Data
(60) Provisional application No. 60/191,468, filed on Mar. 23, 2000.

(30) Foreign Application Priority Data
Mar. 21, 2000 (DK) PA 2000 00476

(51) Int. Cl. H04L 9/32; H04L 12/22

(52) U.S. Cl. 380/277; 713/155; 713/201

(57) ABSTRACT

The invention relates to initial methods and a first system for creating of sites and a subsequent method and a second system for editing of sites to be displayed at a public network to public users wanting to view the sites. The methods comprises the steps of a specific user, wanting to generate his own sites, having delivered from a software house having developed the software program, not to himself but to a chosen hosting partner, a standardized software program including modules and templates. The user may use the modules and the templates for creating and/or editing the sites after the software program has been installed on data storage means at the hosting partner. The user himself never has to program and the user himself never has to deal with installation of the program. This is a great advantage reducing the inconvenience of utilizing software programs and reducing the risk of faults occurring. Also, any update of the software program is supplied directly from the software house to the hosting partner without the user having to deal with updating and installation of any improvements that are or can be made to the program.

### FIELD OF THE INVENTION

The present invention relates to initial methods for creating a number of sites and a subsequent method for editing of sites in a database for displaying the sites in a public network, said sites containing text and/or picture features and said sites being stored on an electronic data storage means in a computer environment, and said data storage means being connected to an electronic browser in the computer environment, said computer environment allowing only a limited number of specific users to both view and edit the sites stored on the data storage means, and said browser allowing an unlimited number of public users to only view the sites stored on the data storage means. The invention also relates to systems for employing the methods and use of such systems.

### BACKGROUND OF THE INVENTION

It is known to administer sites such as web sites for the Internet used to constitute user interfaces between a server or other means of storing data and a user wanting to access the server or the other means in order to view the data stored. Persons having the knowledge in programming in the relevant language of the database used as a basis of the sites generate the sites and the data stored. Such a person is not necessarily a public user of the sites.

After the person having the knowledge in programming have performed the programming the sites are available to any user getting access to the server with a user interface depending on the programming having been performed. If the sites are to be changed or expanded either due to new data having to be stored or because the outlay of the sites are to be changed, then it is necessary to have the person having knowledge in programming to continue the programming in order to have the data or the outlay changed.

This involves some disadvantages. It may delay the changing of the sites because of the necessity of the person programming needing to have the time to change the program in order to have the changes of the sites effectuated. If the change is a change of price due to sudden price changes in a certain market, then it is of absolute importance to have the changes made immediately. Also it may be involved with high costs to have a specific person changing the sites, because such person must be a expert in programming and must have knowledge not only in programming but to a certain extent also in the market for which the sites are intended.

### DISCLOSURE OF THE INVENTION

It is the object of the present invention to provide means for eliminating these disadvantages so that the changing of the sites may be made easier and faster than is possible with the procedures used today.

This object is obtained by a first initial method comprising the steps of creating a site by inserting into a user interface of a software program certain data into a number of fields each of said fields administering given parameters of the site being created, the software program automatically, alternatively an owner of the database being a second specific user manually, alternatively a supplier of rights for using the software program being a fourth specific user, sending a message including a so-called key request to a software house being a first specific user with advise of the site having been created, the first specific user receiving the message from the second specific user, alternatively from the fourth specific user, and validating the data having been inserted by the second specific user, alternatively by the fourth specific user, and validating the identity of the second specific user, alternatively of the fourth specific user, the first specific user then transmitting to the second specific user, alternatively to the fourth specific user, an electronic so-called key string being linked to a serial number related to the site created, and said key string allowing access to the site by a third specific user, the second specific user, alternatively the fourth specific user, inserting into a so-called key repository the key string after which the site is accessible by the second specific user, alternatively by the fourth specific user, or a third specific user.

The object is also obtained by a second initial method comprising the steps of creating a site by inserting into a user interface certain data into a number of fields each of said fields administering given parameters of the sites being created, addressing a user of the site, said user being a third specific user having purchased at least a right for using the software program for editing of sites, the software program automatically, alternatively an owner of the database being a second specific user manually, alternatively a supplier of rights for using the software program being a fourth specific user, sending a message including a so-called key request to the first specific user with advise of the site having been created, the first specific user receiving the message from the second specific user, alternatively from the fourth specific user, and validating the data having been inserted by the second specific user, alternatively by the fourth specific user, and validating the second specific user, alternatively the fourth specific user, the first specific user then transmitting to the second specific user, alternatively to the fourth specific user, an electronic so-called key string being linked to a serial number and said key string allowing access to the site by the third specific user, the second specific user, alternatively the fourth specific user, inserting into the a so-called key repository the data of the key string after which the site is accessible by the third specific user.

The difference between the first initial method and the second initial method is, that in the first case the third specific user has not yet been identified and the site created is “dormant” at the hosting partner until a third specific user wants to purchase a site corresponding to the “dormant” site. In the second initial method, the third specific user has been identified and the site created is created for the third specific user with the data related to the specific wishes and demands of the third specific user in question.

Preferably the initial methods of the invention is employed in combination with a subsequent method, said subsequent method comprising the steps of a specific user accessing the server via the browser, the specific user choosing a number of and kinds of modules among a plurality of different kinds of modules for generating and/or editing a site, the specific user inserting text and/or picture features into the number of and the kinds of modules chosen, the specific user communicating to the browser the modules chosen with the text and/or picture features inserted in order to generate or edit the sites, the browser transmitting said modules to the server and the server receiving the features from the browser, the server generating or editing the sites according to the modules received from the browser and to be stored on the server, and the thus generated or edited sites according to the modules stored on the server subsequently being accessible to public users that are utilising the browser in order to only view the sites.

A first system for performing the initial method of the invention comprises a means such as a server being situated at a second specific user such as a hosting partner and capable of storing electronic data, said means having stored a software program for creating of sites, said software program having been received from a first specific user being a developer of software programs, said means having stored data related to a third specific user being a user wanting to establish sites of his own, said data having been received from the first specific user, i.e. the software developer, or from a fourth specific user being a supplier of the software program or of at least rights for using the software program, said second specific user such as the hosting partner inserting the data into the software program in order to establish access for the third specific user to the sites stored on the means for data storage, and said access being limited by an electronic so-called key string having been given by the first specific user to the second specific user after correlation between the data stored related to the third specific user and the purchase by the user, respectively.

Preferably, the first system is used in combination with a second system according to the invention to be used for performing the subsequent method according to the invention, said second system comprising at least one means for storing data electronically such as a server in a computer environment and comprising a number of modules being stored on a server said modules being capable of generating sites and said system comprising at least one browser having a connection to the server, a number of public users being able to utilise the browser, and a number of specific users also being able to utilise the browser, and where the public users are able to only view the sites on the server via the browser, and where the specific users are able to both view and write to the sites via the browser.

The invention also relates to uses of the first system and the second system.

A first use comprises that the second specific user creates the sites by using a software program and a serial number both received from the first specific user, and where the second specific user in order to allow access to the site by the third specific user uses a key string also received from the first specific user.

A second use comprises that the third specific user in order to edit the sites stored on the server uses a browser to access the server located at the second specific user, and where the third specific user in order to edit the sites uses a software program that the second specific user has received from the first specific user and has installed on the server.

The possibility of a hosting partner by employing the any of the initial methods being capable of creating sites with data supplied by a supplier or a software house by using a first user interface with the fields to be filled out already listed makes it very easy for the hosting partner to input the data necessary for creating the site. It may even not be a person having knowledge in programming which at the hosting partner input the data and thereby installs the site. The installation can be made fast and efficiently without any risk of data necessary not being input as the user interface is supplied by the software house having developed the software program, and therefore all data will be input.

On the other hand the security is being maintained for the software house that the hosting partner does not create sites that have not been purchased at the software house itself or at an authorised supplier of the software program. Because the combination of the serial number and the key string both supplied by the software house is unique and is only known to the software house then it will not be possible to create sites by use of the software program with other combinations of serial numbers and key string than the ones supplied by the software house.

The possibility of a specific third user employing the subsequent method according to the invention and being the one that has the expert knowledge of the market for which the sites are intended, but who need not have the knowledge of programming have the effect that the sites may be edited according to the market and the changes in the market. The editing of the sites is not delayed depending on the availability of a person having knowledge in programming. The editing of the sites by the specific user in stead of the person with knowledge in programming ensures a fast, an updated and a correct edition of the site. However, as the person now editing the sites do not necessarily have the knowledge in programming it is important that the person cannot make any unintended changes or deletions that may jeopardise the whole programming.

Therefore the initial methods are restricted to a certain way of administering the transmitting of information between the first specific user being the software house and the second specific user such as a hosting partner. It is important that the combination of the serial number and the key string is not apparent to the second specific user.

Additionally, the preferred subsequent method is restricted to a certain way of allowing communication between the specific third user being the purchaser and the server or other means on which the data are stored. However, also here it is important that the administering of the communication is not apparent to the user, because the possibility exists of faults occurring, i.e. the communication must take place automatically but safely.

Also, when the user is not directly involved in programming and installation, then there is a much greater safety for those developing the software program that the program is not illegally copied. Furthermore, it will be possible to design the features available to the user in response to the users needs and demands. The user does not have to purchase a complete and expansive program with all features included, also those not needed, but may limit the parts of the program purchased in order to suit his purpose and thereby reduce costs.

### BRIEF DESCRIPTION OF THE DRAWINGS

The invention will now be described more detailed with reference to the accompanying drawings where

FIG. 1 is a schematic flow diagram of the steps involved in a first initial method according to the invention,

FIG. 2 is a schematic flow diagram of the steps involved in a second initial method according to the invention,

FIG. 3 is a schematic flow diagram of the steps involved in a subsequent method according to the invention,

FIG. 4 shows an embodiment of a first user interface between the second specific user and the system, said first user interface showing different fields,

FIG. 5 shows an embodiment of a second user interface between the third specific user and the system, said second user interface, and

FIG. 6 shows an embodiment of a site that is created by use of any of the initial methods by using the initial system according to the invention and the site afterwards being edited by use of the subsequent method by using the subsequent system according to the invention.

### DETAILED DESCRIPTION OF THE DRAWINGS

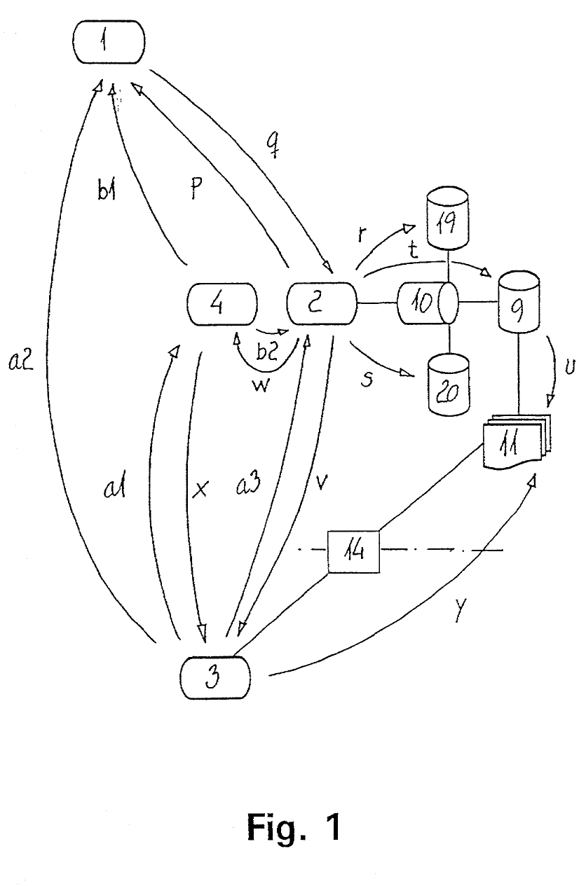

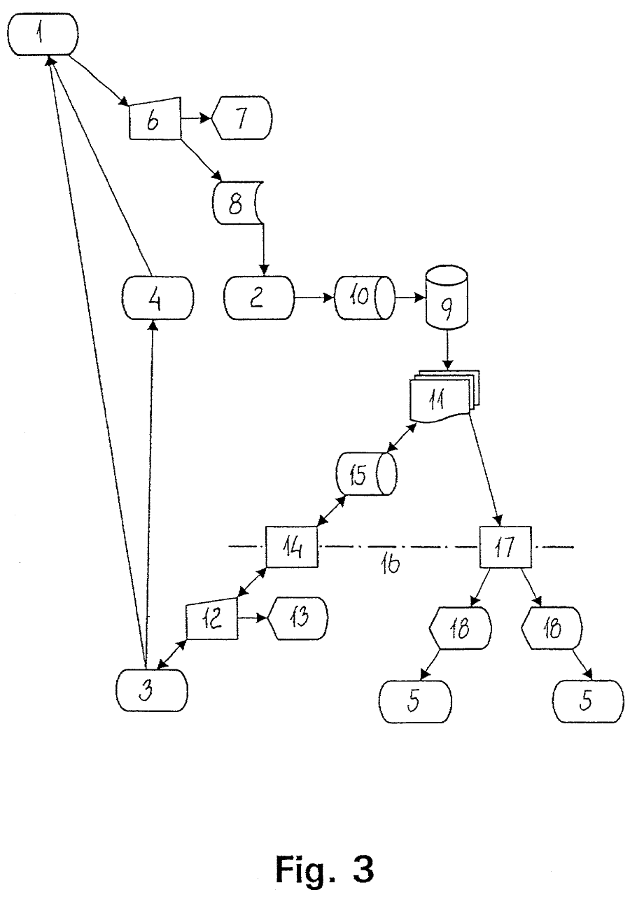

FIG. 1 is a schematic view of basic steps when creating sites by use of a first initial method according to the invention. A software house 1 has developed a software program 8 being able to create sites to be used in advertising or in displaying information in general at a public network 16 such as the internet (see also FIG. 3). A hosting partner 2 having a means 10 for storing data electronically at a data storage means 9 such as a server has access to the public network 16. A user 3 has a browser 14 or other means for accessing the public network 16. A supplier 4 of software programs to users 3 constitutes a marketing link between the user 3 and the software house 1. The methods of the invention to be employed comprises initial methods for creating of sites and a subsequent method (see FIG. 3) for editing of sites. The subsequent method is intended for the user wanting to edit sites of his own to be used at the public network by using the software program having been developed by the software house.

The user 3 contacts the supplier 4 (arrow al) asking for purchasing the software program 8 enabling the user 3 to edit his own sites by employing the subsequent method after the sites 11 have been created by employing the first initial method. Thereafter, the supplier 4 contacts the software house 1 (arrow b1) having developed the software program 8 or contacts a specific hosting partner 2 (arrow b2) hosting the software program. The supplier 4 may inform the software house 1 of a specific hosting partner 2 that either he or the user 3 wants to be used as hosting partner. Alternatively, the software house may propose a hosting partner. It will also be possible for the user 3 to contact the software house 1 (arrow a2) or contact the hosting partner 2 (arrow a3) directly without contacting the supplier 4.

When the choice of hosting partner 2 has been established, the hosting partner 2 sends to the software house 1 (arrow p) a message including data on the site, which the third specific user wants to be created. Along with the message are both a so-called short name designating the site in question and a so-called key request requesting an electronic so-called key string to be allocated the site in order to being able to access and edit the site. The key request is the safety for the software house, that sites cannot be sold or duplicated without access to the key string being an electronic key, which the software house allocates a certain site. Before the key string is transmitted to the hosting partner, the software house validates the identity of the hosting partner and validates that the site, which the third specific user wants to be created, is possible to establish with the software program. When validation has taken place the software house 1 transmits to the hosting partner 2 (arrow q) the key string together with a serial number related to the key string.

The hosting partner has a so-called pending list 19 containing a list of all the sites having been created and having been purchased by a third specific user and awaiting a key string and the serial number related to the key string. Data on the different sites purchased by third specific users are placed in the pending list 19 (arrow r) and the key request is transmitted to the software house 1 (arrow p). The pending list 19 among other information contains the short name of each of the sites of the pending list.

The key string, which the hosting partner 2 receives, is placed in a so-called key repository 20 (arrow s) administered by the hosting partner 2. If the key string, which the hosting partner 2 receives from the software house 1, is related to a site with a short name appearing on the pending list 19, then the site in question may be installed immediately (arrow t). As soon as the site is installed, the third specific user having purchased the rights to the site in question may gain access and start editing the site. The third specific user is informed either directly by the hosting partner (arrow v) or the hosting partner informs the supplier (arrow w), who subsequently informs the third specific user (arrow x)

If the key string, which the hosting partner receives from the software house 1, is not related to a site with a short name appearing on the pending list, then no site has been created yet. Sites not appearing on the pending list are sites, which the hosting partner will create when a third specific user purchases a site. Thus, the hosting partner may have a number of key strings not yet in use, but which ensures that the hosting partner always has a still not used key string available. This is especially advantageous if the hosting partner is generally validated, because it means that the access for the third specific user to a site can take place within a very short period of time. If the site, which the third specific user want to purchase, matches a site with a still not used key string and a serial number relayed thereto in the key repository, the hosting partner may install the site immediately without first having to transmit a key request to the software house.

Apart from the site name and the short name, the user has a pronounced wish of what the so-called type of site should be in order for public users to find the site at a certain location when searching the public network. The site type is also input. The complete address of the site is to be input (Complete URL) and the name of the site is also to be input (IP). It is of course a condition that the address and the name of the site is not being used or reserved by others as a domain-name. After all the above data related to the sit itself has been input, then the site is created. However, in order for the user to afterwards gain access to the site in order to edit the site by inputting text and/or pictures into the site then the user must have a username and a corresponding password in order to assure the user that only he has the access of editing the site. The username and the corresponding password have been chosen by the user and have been informed to the supplier or the hosting partner. The hosting partner inputs the username and the corresponding password.

Now the site for the specific third user has been installed (arrow u) by the hosting partner with all the relevant data for the user to edit the site and the site is ready and already possible for the user to access. The relevant data comprises the number and type of modules that the user has purchased and paid for, the name of the site and the short name. When the third specific user accesses the site, the user has to edit the design of the modules, and the data related to the site at the server and other information related to the user such as a possible username and password, which are known to the user.

The supplier will forward to the user (also arrow x) a possible certificate together with an invoice as well. Now the user will be able to access the site (arrow y) through the public network via the browser 14. The access enables the user to edit the site to his needs and wishes, but limited to the number of modules and the type of modules purchased as determined after the creation and installation by the hosting partner as described above.

In the figure it is shown that the user 3 is allowed access and gains access through the public network and via a browser 14. This way of accessing the sites 11 constitutes a part of the subsequent method described in FIG. 3. It will be possible for the user to being allowed and gaining access in other ways than the one described without departing from the scope of protection of the first initial method according to the invention.

In a preferred embodiment it is possible to input data relating either or both to the supplier of the site or/and to the hosting partner, i.e. the supplier or hosting partner by which the user has purchased the software program or at least the right for using the software program in order to edit sites. Perhaps a link from the site being created to a site of the supplier may be established.

The message with data of the site that the hosting partner has created, and which are sent to the software house may be validates automatically if data of the supplier and/or the hosting partner is part of the message send to the software house. The software house may establish a general validation of given suppliers and/or hosting partners. When messages are received from these the validation may take place automatically without the need for the software house to scrutinise the message. Thereby the validation may take place faster and easier than a manual validation. All, which in fact has to be validated either manually or automatically, is whether the site having been created is capable of subsequently being edited by the third specific user and whether the data on the supplier and/or the hosting partner corresponds to the suppliers and/or hosting partners being generally validated. If these two criteria are fulfilled, the data are validated and the key string with the serial number related to the key string is transmitted to the hosting partner.

It is essential to the first initial method of the invention that the combination of the serial number and the key string is a special combination that is only known by the software house up to the point of time when all the data, but the key string has been transmitted to the hosting partner. Thereafter the combination of the serial number and the key string is also known to the hosting partner, but not known to the user and the supplier. Also the combination of serial numbers and key strings is unique and is defined by the software house Accordingly, it is not possible for the hosting partner to create more sites than having been purchased either by the software house or by a supplier of the software program from the software hose because a random combination of a serial number and a key string will not be a combination selected by the software house The subsequent method of editing the site will not function with random combinations of serial numbers and key strings. This ensures the copyright of the software house in an easy but safe manner.

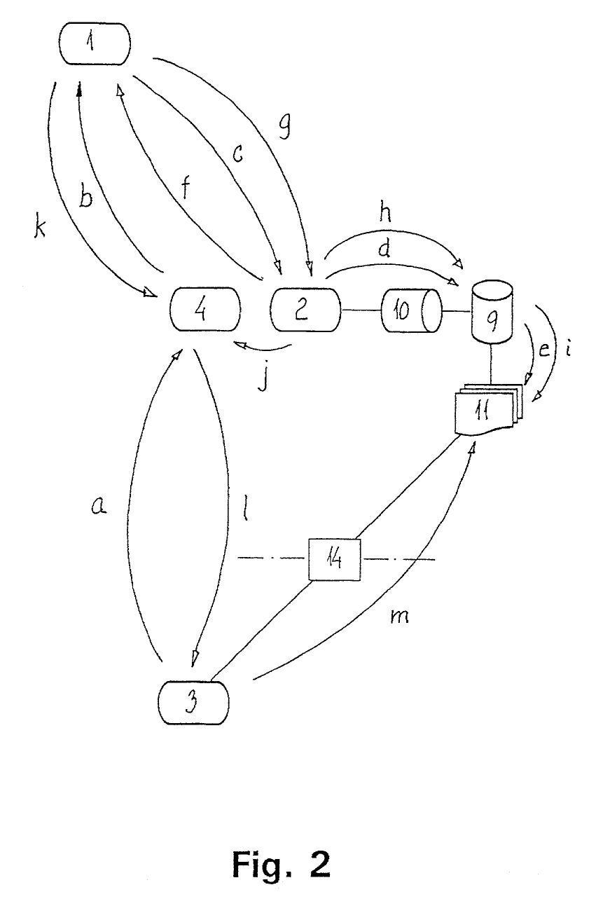

FIG. 2 is a schematic view of basic steps when creating sites by use of a second initial method according to the invention A software house 1 has developed a software program 8 being able to create sites to be used in advertising or in displaying information in general at a public network 16 such as the internet (see also FIG. 3). A hosting partner 2 having a means 10 for storing data electronically at a data storage means 9 such as a server has access to the public network 16 A user 3 has a browser 14 or other means for accessing the public network 16. A supplier 4 of software programs to users 3 constitutes a marketing link between the user 3 and the software house 1. The methods of the invention to be employed comprise any of the initial methods for creating of sites and a subsequent method (see FIG. 3) for editing of sites. The subsequent method is intended for the user wanting to edit sites of his own to be used at the public network by using the software program having been developed by the software house.

The user 3 contacts the supplier 4 (arrow a) asking for purchasing the software program 8 enabling the user 3 to edit his own sites by employing the subsequent method after the sites 11 have been created by employing the second initial method. Thereafter, the supplier 4 contacts the software house 1 (arrow b) having developed the software program 8. The supplier 4 may inform the software house 1 of a specific hosting partner 2 that either he or the user 3 wants to be used as hosting partner. Alternatively, the software house may propose a hosting partner. It will also be possible for the user 3 to contact the software house 1 or the hosting partner 2 directly without contacting the supplier 4.

When the choice of hosting partner 2 has been established the software house 1 transmits to the hosting partner 2 (arrow c) data including a serial number, said serial number being a serial number allocated the specific third user. If the hosting partner has not received the software program 8 for generating of sites at an earlier occasion, then the software house 1 also transmits to the hosting partner the software program 8 in order for the hosting partner to install the software program at his means 9 for data storage.

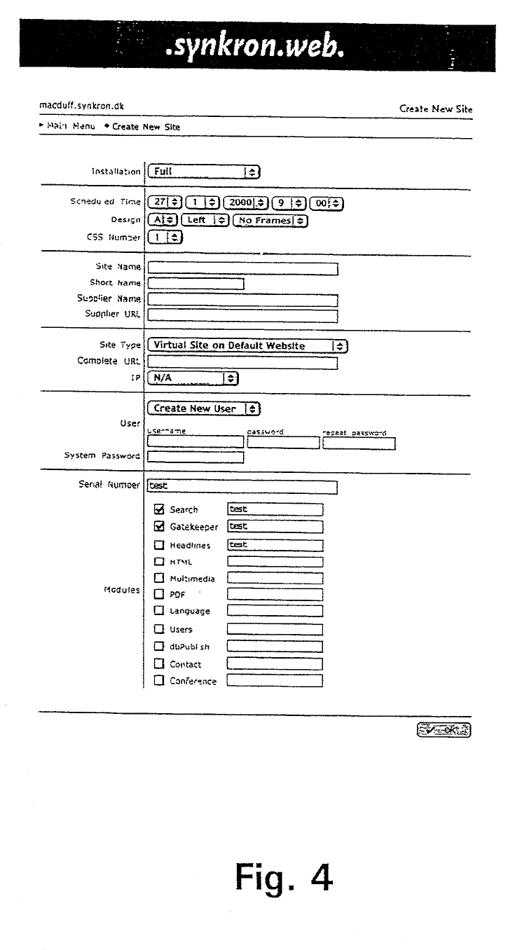

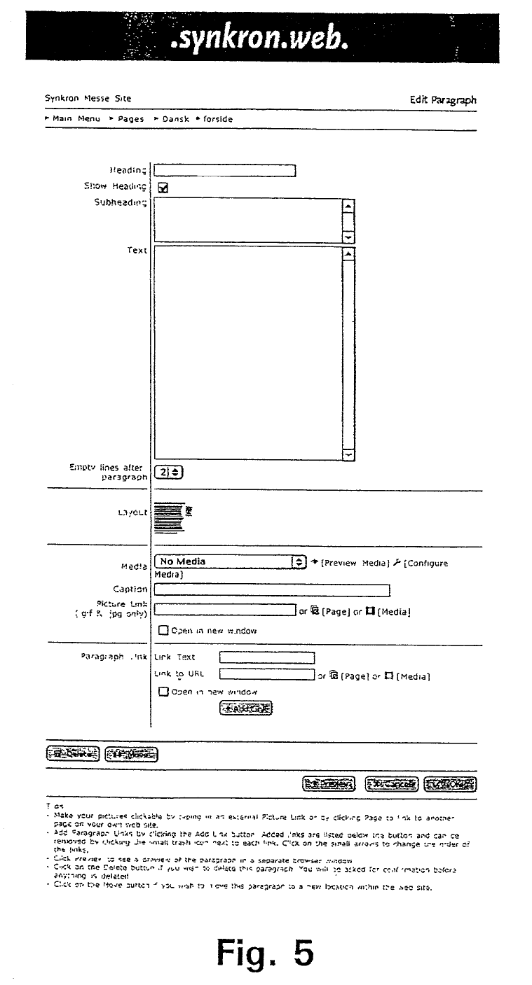

The hosting partner 1 employs the second initial method of the invention in order to create a site 11 for the user 3 before the user 3 is able to edit the site by employing the subsequent method of the invention. A first user interface (see FIG. 4) for creating a new site is presented to the hosting partner. The hosting partner 2 inputs data related to the user into the means for storing data (arrow d). Among the data also the serial number that the software house 1 has transmitted to the hosting partner 2 is input into the first menu. Also, when inputting data, the hosting partner 2 inputs data related to the purchase made by the user 3 so that the user 3 afterwards should have access to edit his site. The user 3 has purchased a number of modules and certain types of modules (see FIG. 5) to be used, and the limitation in editing only the modules purchased is input by the hosting partner. In a preferred embodiment it will also be possible to install the point of time at which access to the site 11 for the user 3 is to established. Thereby it will be possible to ensure that all procedural tasks have been performed by the hosting partner before the user 3 gains access to the site and the facility of editing the site.

After the limitation in the number of modules and the type of modules have been input for the specific user 3, then information about the individual design of the modules is input. The design of the modules comprises the width of columns, the placement of the navigation and if frames are to be used or not. Also the chosen character style sheet of the letters to be used in the written text part of the site is input. After these data has been input a site name is to be input as well. The site name is a name which is an access for the user but which also is a recognition for the hosting partner in the event of any administering of the site such as updating, alteration, deletion and the like administration. If the site name is rather long or complicated or in any other way is not suited for identification of the site in question then a short name may be input which makes it easier for at least the hosting partner to find and recognise the site among other sites stored on the server at the hosting partner.

In a preferred embodiment it is possible to input data relating to the supplier of the site, i.e. the supplier by which the user has purchased the software program or at least the right for using the software program in order to edit sites. Perhaps a link from the site being created to a site of the supplier may be established.

Apart from the site name and a possible short name, the user has a pronounced wish of what the so-called type of site should be in order for public users to find the site at a certain location when searching the public network. The site type is also input. The complete address of the site is to be input (Complete URL) and the name of the site is also to be input (IP). It is of course a condition that the address and the name of the site is not being used or reserved by others as a domain-name. After all the above data related to the sit itself has been input, then the site is created. However, in order for the user to afterwards gain access to the site in order to edit the site by inputting text and/or pictures into the site then the user must have a username and a corresponding password in order to assure the user that only he has the access of editing the site. The username and the corresponding password has been chosen by the user and has been informed to the supplier, the software house and the hosting partner. The hosting partner inputs the username and the corresponding password. Finally the hosting partner inputs the serial number and ticks off the number of and the type of modules that the user has purchased. The user has no knowledge of the serial number that has been transmitted directly to the hosting partner from the software house.

Now the site for the specific third user has been created (arrow e) by the hosting partner with all the relevant data for the user to edit the site and the site is ready, but not yet possible, for the user to access. The relevant data comprises the number and type of modules that the user has purchased and paid for, the design of the modules, and the data related to the site at the server and related to the user such as username and password which are known to the user and the serial number which is only known to the software house and the hosting partner.

However, although all these data has now been input still one piece of data misses in order to complete any of the initial methods of creating the site in order for the user to employ the subsequent method of the invention, i.e. editing the site. The software house has to supply to the hosting partner an electronic so-called key string being an electronic key for opening the access to the site for both the hosting partner but also the user to edit the site. When all the initial data mentioned above has been input then the software program automatically transits a message to the software house (arrow f) that the site has now been created with the data in question especially message of the serial number input is transmitted to the software house. Included in this message to the software house is a so-called key request asking for the key string in order to make the site function so that the user may start editing the site in order for the site to be edited before being accessible for the public user.

When the software house receives the message and verifies that data input is correct, then the key string is transmitted to the hosting partner (arrow g). Afterwards the key string must be input into the server (arrow h). As soon as the key string is input then the site is ready (arrow i), and now possible, for the user to access. The hosting partner gives message to the supplier (arrow j) that the site is now accessible for the user and gives message of the information related to the installation of the site.

At the same time the software house sends to the supplier (arrow k) a certificate proving that the user now has gained access to edit the site by using the subsequent method according to the invention. The software house may also send other items such as a manual of how to employ the subsequent method according to the invention. At this stage the software house will at the latest send an invoice for the purchase of the software program or at least for the right to use the software program for editing the site installed. Lastly, the supplier will forward to the user (arrow l) the certificate and other items received from the software house together with an invoice as well. Now the user will be able to aces the site (arrow m) through the public network via the browser. The access enables the user to edit the site to his needs and wishes but limited to the number of modules and the type of modules purchased as determined after the creation and installation by the hosting partner as described above.

In the figure it is shown that the user 3 is allowed access and gains access through the public network and via a browser 14. This way of accessing the sites 11 constitutes a part of the subsequent method described in FIG. 3. It will be possible for the user to being allowed and gaining access in other ways than the one described without departing from the scope of protection of the second initial method according to the invention.

It is also essential to the second initial method of the invention that the combination of the serial number and the key string is a special combination that is only known by the software house up to the point of time when all the data but the key string has been input into the menu for creating the site. Thereafter the combination of the serial number and the key string is also known to the hosting partner but not known to the user and the supplier. Also the combination of serial numbers and key strings is unique and is defined by the software house. Accordingly it is not possible for the hosting partner to create more sites than having been purchased either by the software house or by a supplier of the software program from the software hose because a random combination of a serial number and a key string will not be a combination selected by the software house The subsequent method of editing the site will not function with random combinations of serial numbers and key strings. This ensures the copyright of the software house in an easy but safe manner.

FIG. 3 is a schematic view of basic steps when editing sites by employing a subsequent method according to the invention. A software house 1 of software programs develops the basic software program necessary to create sites as described in FIG. 1 or FIG. 2 with standard design for the text and/or pictures to be inserted by the subsequent method. The software house 1 develops the software program by manual input 6 and a display 7 showing what is being manually programmed. The software house 1 constitutes a first specific user. A person 3 wanting by himself the possibility to edit sites already created by the second specific user by using any of the initial methods (see FIG. 1 or FIG. 2) and the initial system (see FIG. 1 or FIG. 2) contacts either the software house 1 having developed the software program or a supplier 4 such as a retail dealer of the software programs from the software house 1. In stead of supplying the software program itself, then the supplier 4 may supply only a license for using the software program. The person 3 wanting to edit sites constitutes a third specific user. The person 3 purchases the software program 8 to be installed on a server 9 or on other means for storing data. The person 3 also notifies the software house 1 or the supplier 4 of which server or which other means for storing data that the software program 8 is to be installed. Alternatively, the supplier or the software house chooses the server or other means of data storage to install the software program or chooses a server or other data storage means at which the software program is already installed. This may be a server or other means for storing data electronically.

Depending on whether the software program 8 has been purchased at the software house 1 itself or at a supplier 4 of the software program such as a retail dealer 4, then the software house 1 itself or the supplier 4 via the software house 1 takes the responsibility to install the software program 8 on the server 9 notified by the user 3 or to create the third specific user as an authorised user of an already installed software program. Normally the server 9 will be a server placed at a so-called hosting partner 2. In special circumstances, the third specific user 3 and the second specific 2 user may be the one and same user, i.e. the second specific user not being a hosting partner as such. In the following a hosting partner will be used as an example of a second specific user. However, this should not construe any limitation to the users that may be the second specific user

As mentioned in the description of FIG. 1 and FIG. 2 the software house 1 delivers the software program 8 to the hosting partner 2 and the hosting partner 2 installs the software program 8 at the server 9 by means of a direct access 10 to the server 9. The deliverance of the software program 8 takes place either by sending the software program 8 electronically to the hosting partner 2 or by sending data carriers such as diskettes or CD-ROM to the hosting partner 2.

Thus, the third specific user 3 and the possible retail dealer 4 do not get any knowledge of the software program 8 that is installed on the server 9 or on the other means of storing data. Only the software house 1 and the hosting partner 2 have knowledge of the software program 8 being installed. This means that there is no risk that the third specific user 3 purchasing the software program 8 or purchasing a license to use the software program 8 already installed changes or deletes the software program itself. When the software program 8 is installed and the relevant data related to the third specific user 3 has been entered, then the third user is able to access by means of a common browser 14 sites 11 through a second user (see FIG. 5) interface between the user 3 and the sites 11 generated by the software program 8 stored on the server 9. This user interface has menus from which the user 3 can generate and edit the sites 11. The access to sites 11 on the server 9 through the first user interfaces takes place via a public network 16 such as the Internet and via the common browser 14 such as Netscape Navigator, Microsoft Internet Explorer, Service Pack, Windows NT or other similar software system being capable of establishing communication through the public network 16 between decentralised situated users and centralised situated data storage means.

When the third specific user 3 has firstly generated and subsequently perhaps edited the sites 11 by means of manual input 12, said manual input 12 being viewed by a display 13 and a direct storage access 15 then the specific user 3 can release the sites 12 to public users 5. The public users 5 access the sites 11 via the public network 16 such as the Internet or other public network coupled to the server 9 and via a common browser 17 that is suitable for searching on for the public network 16 in question. Viewing the sites 11 takes place through second user interfaces at displays 18 situated at the public users 5.

However, when the software program 8 that is used to generate the sites 11 has been further developed by the software house 1 as example being updated with new possibilities for creating and/or editing text and picture features, it is necessary to update the software program 8. The software house 1 of the software program 8 does this by further sending either electronically or on a data carrier the updated version of the software program 8 to the hosting partner 2. Thus, neither the specific user 3, nor the supplier 4 nor the public user 5 will have to be involved when installing the updated version of the software program 8. However, they will have the advantages of the updated version of the software program 8 from the moment that the updated software program 8 is installed on the server 9 at the hosting partner 2.

The knowledge of the content of the software program 8 being limited to the software house 1 of the software program and to the hosting partner 2 has several advantages. As mentioned, there is no risk that the specific user 3 or the supplier 4 changes or by accident deletes the program. Also, there is the advantage that it is impossible to copy and to distribute piratical editions of the software program. Furthermore, the ongoing updating of the program can be distributed to all of the relevant hosting partners 2 at the same time. This means that all specific users 3 have the advantage of the updated version of the software program 8 at the same time which is an advantage to the hosting partners 2 not risking other hosting partners being first with the updated version and thereby having a competitive advantage.

Administering sites in this way is both easy and safe to the specific user 3 and is also easy to the hosting partner 2. The development and update of the software program takes place centrally at the software house 1 without having to involve other persons with knowledge of programming. Also, it is not necessary for the software house 1 to have any knowledge of the markets for which the sites that are to be generated and/or edited by the program are to be used. The software house 1 can concentrate wholly on developing and improving the functionality and the design features of the program, and do not have to deal with the content, i.e. the actual text and/or pictures of the sites.

On the other hand the supplier 4 and the specific user 3 do not need any knowledge of programming. They can concentrate on the content of the sites, i.e. the actual text and/or pictures. Also, they have to choose which of the design features which are to be used in the sites, but they choose among standard design features and need not develop the design features themselves. They can choose any of the standardised design features, but they need only use some of them, and they can always enhance or limit the use to more or fewer design features, respectively, than formerly chosen.

FIG. 3 shows schematically a possible set-up for applying the any of the initial and the subsequent method according to the invention by using the system according to the invention. A software house 1 of the software program for generating and editing of sites are called a first specific user. A hosting partner 2 having a server 9 for storing the software program is called a second specific user. A user 3 wanting to make use of the program in order to generate and/or edit sites is called a third specific user. The user 3 being the third specific user may either purchase the software program through the software house 1 itself or through a retail dealer 4 having business relationships with the software house 1. Lastly, a person 5 wanting to view the content of the sites is called a public user. The number of public users is unlimited in the sense that there is no limitation from the software program of who may view the sites. The only limitation is the number of public users having access to the server 9 at the hosting partner 2. Access to the hosting partner is obtained through a common browser 15 such as Netscape Navigator or Microsoft Internet Explorer. This is the case not only for the public users 5 but also for the third specific user 3.

A possible transaction of communications may be as follows. The third specific user 3 contacts the retail dealer 4 or the software house 1 for purchasing the program for generating and editing sites. If the third specific user 3 contacts the retail dealer 4, then the retail dealer 4 afterwards contacts the software house 1. When receiving the notice that a third specific user 3 has purchased the software program it is necessary for the software house 1 to know which hosting partner 2 that the third specific user 3 wants to use. When having received the notice of purchase and having been informed of the hosting partner 3 that the user 3 wants to use, then the retail dealer 4 or the software house 1 sends to the hosting master 2 relevant data related to the third specific user. Preferably, the sending of data takes place electronically.

When the software program has been installed on the server 9, then the third specific user 3 is notified of the completion of the installation. Hereafter, the third specific 3 user may access the server 9 at the hosting partner and access his version of the software program in order to generate new sites by use of the design features of the program and by creating the content, i.e. the text and/or pictures of the sites. Alternatively, the third specific user 3 may edit already generated sites either by creating new text and/or pictures or by changing existing text and/or pictures.

The third specific user 3 accesses the server 9 via a common browser 14. This means that the third specific user 3 generates and edits the sites by use of a browser 14 which is commonly known and which is easily accessible, thereby not creating any problems to the third specific user 3 in accessing the server 9. When the third specific user 3 has created the sites or has changed the already generated sites, then the user 3 releases the sites. After the sites have been released then the sites are accessible by public users wanting to view the content of the sites. The public users also access the sites through a common browser and view the sites through the second user interface, which is the actual outlay of the sites as they should be viewed by public users.

The figure shows a possible set-up of a system and communications between a first specific user, a second specific user, a third specific user, a supplier and a public user. The first specific user is the person or firm having developed the software program, a so-called software house. The software program includes modules and templates that are capable of generating the sites. The second specific user is a so-called hosting partner. The hosting partner is a firm hosting sites for different owners of sites and a firm ensuring that outside users, the so-called public users, can access the sites stored at the hosting partner. The sites are normally stored at a server, but may be stored at other means for electronic storage. The third specific user is a person wanting to generate his own sites and thus being an owner of the sites. However, the third specific user does not himself have a server or other means for electronically storing data and capable of functioning as a hosting server. Also, the third specific user does not have or does not want to have the resources to generate the software program necessary for generating sites.

The retail dealer is a firm such as a software dealer, an advertising agency or other firms having either software programs or advertising as one of their business areas. The public user is a person wanting to view the sites generated or edited and stored on the server at the second specific user, the hosting partner. Between at least the third specific user, the sites owner and the second specific user, the hosting partner, and between the public user and the hosting partner browser means constitute the communication means to the server at the hosting partner, at which server the sites, as mentioned, is stored.

The use of the system takes place as follows. The third specific user, yet not having sites of his, contacts either the software house directly or the supplier in order to purchase the software program capable of generating sites. After having purchased the software program the third specific user does not himself receive data carrier means such as diskettes or CD-ROM's. In case the third specific user has purchased the software program at the supplier, then the supplier gives the software house advise of the third specific user having purchased the software program. Thereafter, the software house sends to the hosting partner relevant data related to the third specific user. It is assumed that the software house initially already has sent the software program to the hosting partner so that the hosting partner already has the software program installed on the server before receiving the data related to the third specific user. The sending of the software program may be effected by means of physically sending data carrier means to the hosting partner or may be effected by electronically sending the software program to the hosting partner. Thereafter the hosting master installs the program on the server at the hosting partner. The installation is made once and for all as a first time installation, non-depending on the subsequent number of times that the software program has to be used to create sites for different third specific users.

When the site has been created by the hosting partner by inputting the relevant data related to the third specific user, then the third specific user is being notified either directly by the hosting partner or by the software house or the supplier. When the third specific user has been notified then the user may access the program stored on the server and thus the program with the modules and the templates generating the sites. The third specific user accesses the server through the browser in order to firstly generate the sites and perhaps subsequently in order to edit the sites. As mentioned, the sites are generated by templates that are enclosed in different modules (see FIG. 4 and FIG. 5). The third specific user is the only one having access to the templates and the modules of the software program that he has purchased. Thereby the owner of the sites is the only one having the possibility to generate and edit the sites.

The third specific user chooses among a number of modules each having a number of templates. The modules are a sort of headlines of what is to be generated or edited. The number of and the type of modules are displayed at a primary user interface between the third specific user and the software program installed on the server at the hosting partner. The templates are secondary user interfaces, which are the actual interface that the third specific user utilises when generating or editing text and/or pictures (see FIG. 4 and FIG. 5). The number of modules and templates chosen and the different types of modules and templates chosen are individual to the individual third specific users. After the third specific user have generated or edited the templates and thereby the sites, and after the third specific user perhaps has previewed the sites before releasing the sites to public users, then the sites are available immediately to the public users through the browsers that the public users utilises to access the server at the hosting partner.

FIG. 4 is a printout of a first user interface. The user interface shows a menu containing fields for the input by the second specific user such as a hosting partner of the data necessary for creating a site. The different fields are described with reference to FIG. 1 or FIG. 2. As can be seen all the fields necessary for creating a site is supplied by the software house and it is up to the second specific user to only fill in the appropriate data in the relevant fields. The data is supplied by the software house after having received information from the supplier of the demands of the third specific user having purchased the software program or at least the right to use the program for creating an editing of. It is possible through the interface to limit the numbers of modules depending on the demands from the third specific user for thereby reducing the costs for purchasing the software program with the modules and the templates. It is up to the individual third specific user depending on the need for the individual modules and depending on the costs that the specific user will spend. If the user has chosen among the modules a number of modules and specific types of modules it will later on be possible to supplement or substitute the modules chosen earlier.

FIG. 5 is a printout of a second user interface between the server and a third specific user. The user interface shows a template of one of the modules, the names of said modules shown in the printout in FIG. 4. The template shown is one type and layout of a template. Other types of templates and another lay-out of the templates are possible depending on the module that the template constitutes a part of. The secondary interface is for the specific user to actually input text and/or pictures. It will be possible to limit the types of and the numbers of templates for each of the modules chosen and thereby reducing the costs for purchasing the software program with the modules and the templates. It is up to the individual third specific user depending on the need for the individual modules and depending on the costs that the specific user will spend. If the user has chosen among the templates for each module a number of templates and specific types of templates it will later on be possible to supplement or substitute the templates chosen earlier.

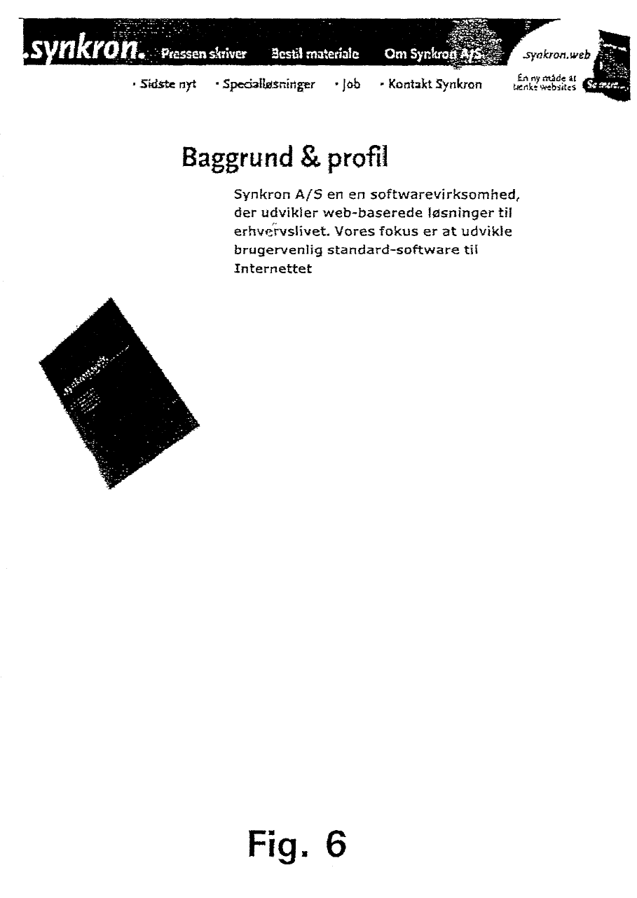

It is important to emphasise that the interfaces shown in FIG. 4 and FIG. 5, respectively, are not the actual sites generated, but is the interfaces that the second specific user and the third specific user, respectively, utilises when creating and/or editing the site. However, it is the sites themselves that the public user views when accessing the server at the hosting partner through a browser means, as example see FIG. 6. The modules chosen and utilised by the third specific user and the text and/or pictures communicated to the templates for each of the modules are the ones that generate the sites. The sites will have a totally different layout than the user interfaces shown in FIG. 4 and FIG. 5.

As a reference to FIG. 4 and FIG. 6, a declaration is made that the textual matter (being in the English language) and pictorial content of the figures neither contain any information defining the scope of protection nor has a meaning necessary for understanding the invention apart from what is described above.

If the first specific user, the software house, develops further features of the software program, as example by developing new modules or more templates for each of the modules, it is not necessary for the third specific user to be aware of this and not necessary to purchase further software programs. The software house may just send, either on a data carrier or electronically, to the hosting partner the updated version of the software program. However, it may be possible to inform the third specific users of the further development of the software program and then have the third specific users chose whether they want to update or not, perhaps with some payment for having the software program updated.

FIG. 6 is an example of a site created by use of a system employing any of the initial methods according to the invention and edited by use of a system employing the subsequent method of the invention. As a reference to FIG. 6, a declaration is made that the textual matter (being in the Danish language) and pictorial content of the figure neither contain any information defining the scope of protection nor has a meaning necessary for understanding the invention.

1. A method being an initial method for creating a number of sites in a database for displaying the sites in a public network,
said method comprising creating a site in a software program by inserting into a user interface certain data into a number of fields each of said fields administering given parameters of the site being created,
the software program automatically, alternatively an owner of the database being a second specific user manually, alternatively a supplier of rights for using the software program being a fourth specific user, sending a message including a so-called key request to a software house being a first specific user with advise of the site having been created,
the first specific user receiving the message from the second specific user, alternatively from the fourth specific user, and validating the data having been inserted by the second specific user, alternatively by the fourth specific user, and validating the identity of the second specific user, alternatively of the fourth specific user,
the first specific user then transmitting to the second specific user, alternatively to the fourth specific user, an electronic so-called key string being linked to a serial number related to the site created, and said key string allowing access to the site by a third specific user,
the second specific user, alternatively the fourth specific user, inserting into a so-called key repository the key string after which the site is accessible by the second specific user, alternatively by the fourth specific user, or a third specific user.

2. A method according to claim 1, where
a third specific user purchases from the second specific user, alternatively from the fourth specific user, at least the right for using the software program to edit a site having been created,
the second specific user, alternatively the fourth specific user, allocating to the third specific user a key string from the key repository and a serial number related to a site being capable of being edited by the right to the software program having been purchased by the third specific user, and
the third specific user thereafter gaining access to the software program for editing the site, said editing involving editing the user interface such as design and content.

3. A method according to claim 1 or claim 2, where
the validation made by the first specific user on the data having been inserted by the second specific user, alternatively by the fourth specific user, and the identity of the second specific user, alternatively of the fourth specific user, is made automatically by a further software program,
said automatic validation taking place when the second specific user, alternatively the fourth specific user, is initially so-called trusted, said initially trusting comprising the first specific user already having validated the identity of the second specific user, alternatively of the fourth specific user, and already having validated future sites created by and being advised by the second specific user, alternatively by the fourth specific user,
the first specific user then automatically transmitting to the second specific user, alternatively to the fourth specific user, the key string related to the site created, and said key string allowing access to a site by a third specific user, and
the second specific user, alternatively the fourth specific user, inserting into a so-called key repository the key string after which the site is accessible by the second specific user, alternatively by the fourth specific user, or a third specific user.

4. A method being an initial method for creating a number of sites in a database for displaying the sites in a public network,
said method comprising creating a site by inserting into a user interface certain data into a number of fields each of said fields administering given parameters of the sites being created,
addressing a user of the site, said user being a third specific user having purchased at least a right for using the software program for editing of sites,
the software program automatically, alternatively an owner of the database being a second specific user manually, alternatively a supplier of rights for using the software program being a fourth specific user, sending a message including a so-called key request to the first specific user with advise of the site having been created,
the first specific user receiving the message from the second specific user, alternatively from the fourth specific user, and validating the data having been inserted by the second specific user, alternatively by the fourth specific user, and validating the second specific user, alternatively the fourth specific user,
the first specific user then transmitting to the second specific user, alternatively to the fourth specific user, an electronic so-called key string being linked to a serial number and said key string allowing access to the site by the third specific user,
the second specific user, alternatively the fourth specific user, inserting into the a so-called key repository the data of the key string after which the site is accessible by the third specific user.

5. A method according to claim 1 or claim 4 and being an initial method for creating a number of sites in a database for displaying the sites in a public network,
said method comprising creating a site by inserting into a user interface certain data into a number of fields each of said fields administering given parameters of the sites being created,
addressing a user of the site, said user being a third specific user having purchased at least a right for using the software program for editing of sites,
addressing a so-called serial number, said serial number relating to the third specific user with the right for at least using the software program,
said so-called serial number defining the user and defining a number of modules and other related data of the purchase by the user,
addressing an electronic so-called key string, said key string relating the third specific user with the so-called serial number,
the software program automatically, alternatively an owner of the database being a second specific user, alternatively a supplier of rights for using the software program being a fourth specific user, manually, sending a message including the key string to the first specific user with advise of the site having been created,
the first specific user receiving the advise from the second specific user, alternatively from the fourth specific user, and validating whether the data having been inserted by the second specific user, alternatively by the fourth specific user, correlates with the so-called serial number
the first specific user then transmitting to the second specific user, alternatively to the fourth specific user, the key string being linked to the serial number and said key string allowing access to the site by the third specific user, and
the second specific user, alternatively the fourth specific user, inserting into the user interface the data of the key string in a certain field after which the site is accessible by the third specific user.

6. A method according to any of claims 1-5, wherein the method comprises also allocating a so-called short name related to a certain site having been created and said short name identifying a certain site having been created, said short name being linked to a key string from the key repository, when the site is purchased by a third specific user,

7. A method according to claim 6, wherein the method comprises creating a number of sites, allocating a short name to each of the sites having been created, and listing the short names of each of the sites in a so-called pending list, said pending list containing short names not yet being linked to a key string from the key repository.

8. A method according to any of claims 1-7, wherein the method comprises also inserting into the user interface a password relating the serial number to both the second specific user, alternatively the fourth specific user, and the third specific user, said password limiting the possibility of editing the sites.

9. A method according to any of claims 1-8, wherein the method comprises inserting data related to the fourth specific user, said fourth specific et least being a supplier of rights for using the software program, alternatively being a supplier of the software program itself.

10. A method according to any of the preceding claims, wherein the method comprises inserting data related to the design of the site, said data being specified by the supplier depending on the wishes and demands of the third specific user having purchased at least the right to use the software program for editing of sites.

11. A first system for performing the initial method according to claim 1-10,
said system comprising a means such as a server being situated at a second specific user such as a hosting partner and capable of storing electronic data,
said means having stored a software program for creating of sites, said software program having been received from a first specific user being a developer of software programs,
said means having stored data related to a third specific user being a user wanting to establish sites of his own, said data having been received from the first specific user, i.e. the software developer, or from a fourth specific user being a supplier of the software program or of at least rights for using the software program,
said second specific user such as the hosting partner inserting the data into the software program in order to establish access for the third specific user to the sites stored on the means for data storage,
and said access being limited by an electronic so-called key string having been given by the first specific user to the second specific user after correlation between the data stored related to the third specific user and the purchase by the user, respectively.

12. A system according to claim 11 where
the software program when being used by the second specific user to input data related to the third specific user exibits a user interface with standardised fields in which to input the data,
and the software program being capable of transforming the data input by the second specific user such as the hosting partner to a design of the site being created and to relate the design to the third specific user,
and the software program being able to show the design to only the second specific user and to control the subsequent activation of the site before allowing access to the third specific user and before the site is functioning as a means for informing or advertising public users.

13. Use of a system according to claim 11 or claim 12, where the second specific user creates the sites by using a software program and a serial number both received from the first specific user, and where the second specific user in order to allow access to the site by the third specific user uses a key string also received from the first specific user.

14. A method being a subsequent method for editing a number of sites in a database for displaying the sites in a public network,
said sites containing text and/or picture features and said sites being stored on an electronic data storage means in a computer environment, and said data storage means being connected to an electronic browser in the computer environment,
said computer environment allowing only a limited number of specific users to both view and edit the sites stored on the server,
said browser allowing an unlimited number of public users to only view the sites stored on the data storage means,
the method comprising the steps of a specific user accessing the data storage means via the browser,
the specific user choosing a number of and kinds of modules among a plurality of different kinds of modules for editing a site,
the specific user inserting text and/or picture features into the number of and the kinds of modules chosen,
the specific user communicating to the browser the modules chosen with the text and/or picture features inserted in order to edit the sites,
the browser transmitting said modules to the data storage means and the data storage means receiving the features from the browser,
the server editing the sites according to the modules received from the browser and to be stored on the data storage means, and
the thus edited sites according to the modules stored on the data storage means subsequently being accessible to public users that are utilising the browser in order to only view the sites.

15. A method according to claim 14 comprising the steps of
firstly, storing on the data storage means a number of standardised modules for editing sites,
secondly, said modules creating first user interfaces being presented to the specific users via the browser when the specific users accesses the data storage means,
thirdly, the specific user via the browser utilising the first user interfaces when inserting text and/or pictures into the modules stored on the data storage means, and
fourthly, the sites being accessible to public users by means of second user interfaces, when the public users utilises the browser to only view the sites stored on the data storage means.

16. A method according to claim 15,
where the specific users choose between a certain number of modules and a certain number of templates when communicating text and/or picture features to the sites,
and where the specific users combines the number of chosen modules with the number of chosen templates optionally for communicating text and/or picture features to certain parts of the sites.

17. A method according to any of claims 14-16 for editing of already stored sites on the data storage means where
the sites stored on the data storage means may be edited by a second specific user having access to the data storage means,
said second specific user receiving, from a first specific user having developed the sites but not having access to the data storage means, a software program to be used in editing the already stored sites,
and the second specific user editing the already stored sites by applying the software program.

18. A method according to claim 17 comprising a procedure of editing a number of text and/or picture features contained in chosen modules constituting a number of sites, the procedure comprising the steps of
choosing at least one module, producing new text and/or picture features by changing the features already contained in the modules and maintaining the edited modules as those constituting the number of sites.

19. A method according to claim 18, where the modules chosen by the third specific user is individual to the user, and where the content of the modules is individual to the user.

20. A method according to claim 19 where the modules chosen by the third specific user is the proprietor of the specific modules chosen with the specific content of the modules chosen and where the third specific user is the only one knowing the modules chosen and knowing the content of the modules.

21. Method according to any of claims 18-20 where the content of the modules is known only to the third specific user, and where the third specific user is the only user having access to edit the content of the modules.

22. Method according to any of claims 18-21 where the number of modules that the third specific user may choose among are a certain maximum numbers and that the modules chosen are the active modules and that the modules not chosen are the dormant modules and where the dormant modules may be altered to active modules by communicating text and/or picture features to the dormant modules.

23. Method according to any of claims 18-22 where the content of the modules is changed by changing a number of templates that constitute the modules and that each template is changed by inserting text and/or picture features in certain parts of the templates.

24. A subsequent system for performing the method according to any of claims 14-23,
said system comprising at least one means for storing data electronically such as a data storage means in a computer environment and comprising
a number of modules being stored on a data storage means said modules constituting sites and said system comprising at least one browser having a connection to the data storage means,
a number of public users being able to utilise the browser, and a number of specific users also being able to utilise the browser, and
where the public users are able to only view the sites on the data storage means via the browser, and where the specific users are able to both view and write to the sites via the browser.

25. A system according to claim 24 where
a software program is stored on a data storage means said program being able to change a content of the modules and thereby being able to change the sites on the data storage means, and
said program being accessible by at least a second specific user, optionally also by a first specific user, said second specific user having access to the program directly through the data storage means, but not being able to change the content of the modules, and
said program being operable only by a first specific user, said first user however not having direct access to the data storage means and said first user also not being able to change the content of the modules.

26. A system according to claim 24 or 25 where
the software program when receiving communication from the first specific user exibits a first user interface with standardised design that is presented to a specific user when the specific user accesses the data storage means in order to edit the content of the modules stored on the data storage means by transmitting the communication to the first user interface,
and the program being capable of transforming the communication of text and/or picture features received from the specific user through the first user interface to the modules so that the sites afterwards may be viewed through a second user interfaces with individual design.

27. A system according to any of claims 24-26 where each of the modules consist of a number of templates, and where editing of the sites may be effected by changing the templates.

28. A system according to claim 27 where each of the templates constitute an individual first user interface accessible to the specific user and where changing of the content of the modules take place by changing certain parts of the templates.

29. A system according to any of claims 24-28 where a first specific user is a software developer, a second specific user is a hosting partner, a third specific user is a sites proprietor, and a public user is a person wanting to view the sites.

30. A system according to claim 29, where a second public user is a supplier of browser means, and that the public user wanting to view the sites are a first public user, and that the first public user receives from the second public user the browser for accessing the data storage means that is located at the second specific user.

31. Use of a system according to any of claims 24-30, where the third specific user in order to edit the sites stored on the data storage means uses a browser to access the data storage means located at the second specific user, and where the second specific user in order to edit the sites uses a software program received from the first specific user by applying the software program into the data storage means.
